(19) United States
(12) Patent Application Publication
(10) Pub. No.: US 2026/0320372 A1
(43) Pub. Date: Oct. 15, 2026

(54) OPERATING METHOD OF ARTIFICIAL INTELLIGENCE PLATFORM AND APPARATUS THEREOF

(71) Applicant: Acryl Inc., Seoul (KR)

(72) Inventors: Su Gi Lee, Seoul (KR); Chan Yong Kim, Seoul (KR); Min Gyu Choi, Gyeonggi-Do (KR); Hyun Kyeong Shin, Seoul (KR); Wei Jin Park, Seoul (KR)

(73) Assignee: Acryl Inc., Seoul (KR)

(21) Appl. No.: 18/858,036

(22) PCT Filed: Dec. 4, 2023
(86) PCT No.: PCT/KR2023/019796

§ 371 Date: Oct. 18, 2024

(30) Foreign Application Priority Data
Nov. 14, 2023 (KR) 10-2023-0157726

(51) Int. Cl. G06N 3/08

(52) U.S. Cl. CPC G06N 3/08

(57) ABSTRACT

The following disclosure relates to an operating method of an artificial intelligence (AI) platform, which may obtain a plurality of personality models by training an artificial neural network model with multi-modal personality data, interlock the plurality of personality models with a pipeline-based artificial intelligence (AI) service, generate a user personality model by combining the plurality of personality models, based on an input of a user for the artificial intelligence (AI) service, and update the artificial intelligence (AI) service based on the user personality model.

### TECHNICAL FIELD

The following disclosure relates to an operating method of an artificial intelligence platform and an apparatus thereof.

### BACKGROUND ART

An artificial intelligence platform facilitates training and servicing of an artificial intelligence model. In general, an artificial intelligence (AI) platform may include features to provide development convenience, such as automation of development environment construction, dataset management, training, services, and the like, and administrative features such as model management, resources management, and monitoring. Using an artificial intelligence (AI) platform, multiple versions of artificial intelligence (AI) learning outputs may be managed and automatically distributed to be serviced, and smoother processing of requests may be possible using automated load balancing of requests occurring.

### DISCLOSURE OF THE INVENTION

### Technical Goals

Embodiments relate to a method of training a personality model on an artificial intelligence (AI) platform and applying the personality model to an artificial neural network model to develop an artificial neural network model that reflects a type of personality a user desires.

The technical goals to be achieved by the present invention are not limited to those described above, and other technical goals not mentioned above can be clearly understood from the following description and accompanying drawings by one having ordinary skill in the technical field to which the present invention pertains.

### Technical Solutions

An operating method of an artificial intelligence (AI) platform according to an embodiment may include obtaining a plurality of personality models by training an artificial neural network model with multi-modal personality data, interlocking the plurality of personality models with a pipeline-based artificial intelligence (AI) service, generating a user personality model by combining the plurality of personality models, based on an input of a user for the artificial intelligence (AI) service, and updating the artificial intelligence (AI) service based on the user personality model.

The multi-modal personality data may include at least one of linguistic, paralinguistic, and non-linguistic information.

Each of the plurality of personality models may include personality models trained with personality data labeled with Big 5 (OCEAN) factors and specialized for a single personality.

The interlocking may include providing the plurality of personality models to a user interface of the artificial intelligence (AI) service.

The generating of the user personality model may include determining, based on a prompt input of the user and a selection input of the user on the user interface, a prioritization and a degree of reflection among the plurality of personality models.

The generating of the user personality model may include evaluating a user personality model in an intermediate stage that is a combination of the plurality of personality models and iterating an operation of combining the plurality of personality models changing a priority and a degree of reflection among the plurality of personality models until performance set by the user is achieved.

The artificial intelligence (AI) service may be configured to generate an artificial neural network model suitable for the user, based on the input of the user.

The user personality model may be configured to pre-process a user input for a language model of the artificial intelligence (AI) service or post-process an output of the language model of the artificial intelligence (AI) service.

The operating method of the artificial intelligence (AI) platform may further include providing a user interface for distributing an artificial neural network model generated based on the input of the user in the updated artificial intelligence (AI) service.

An electronic device according to an embodiment may include a memory including instructions and a processor configured to obtain a plurality of personality models by training an artificial neural network model with multi-modal personality data, interlock the plurality of personality models with a pipeline-based artificial intelligence (AI) service, generate a user personality model by combining the plurality of personality models, based on an input of a user for the artificial intelligence (AI) service, and update the artificial intelligence (AI) service based on the user personality model.

### BRIEF DESCRIPTION OF DRAWINGS

FIG. 1 is a flowchart illustrating an operation of an artificial intelligence (AI) platform, according to an embodiment.

FIG. 2 is a block diagram schematically illustrating a personality model service, according to an embodiment.

FIG. 3 is a diagram schematically illustrating a personality model being used in a pipeline form, according to an embodiment.

FIG. 4 is a diagram illustrating an example of a pipeline, according to an embodiment.

FIG. 5 is a block diagram illustrating an electronic device according to an embodiment.

### BEST MODE FOR CARRYING OUT THE INVENTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

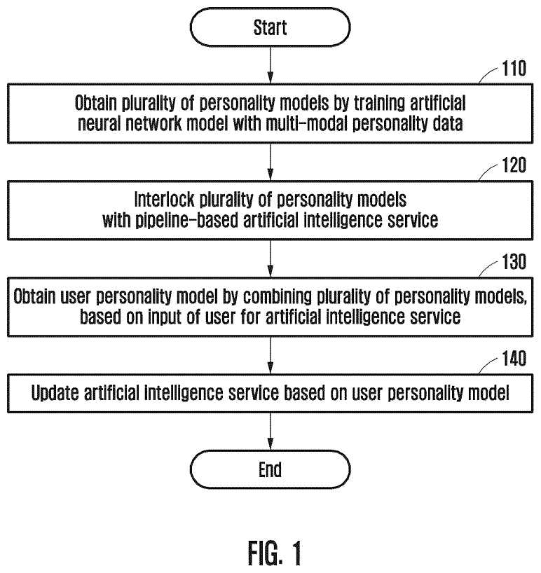

FIG. 1 is a flowchart illustrating an operation of an artificial intelligence (AI) platform, according to an embodiment.

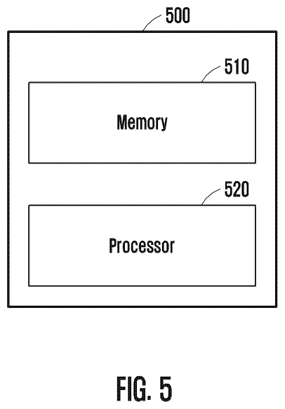

For ease of description, operations 110 to 140 are described as being performed using an electronic device 500 shown in FIG. 5. However, operations 110 to 140 may also be performed by another suitable electronic device in a suitable system.

Furthermore, the operations shown in FIG. 1 may be performed in the shown order and manner. However, the order of some operations may change, or some operations may be omitted without departing from the spirit and scope of the shown embodiment. The operations shown in FIG. 1 may be performed in parallel or simultaneously.

In operation 110, a processor according to an embodiment (e.g., a processor 520 of FIG. 5) may obtain a plurality of personality models by training an artificial neural network model with multi-modal personality data. The processor 520 may control the overall operation of an electronic device 500. In an embodiment, the processor 520 may be implemented as an array of a plurality of logic gates or may be implemented as a combination of a general-purpose microprocessor and a memory in which a program executable by the microprocessor is stored. In addition, it is to be understood by one of ordinary skill in the art to which the present embodiment pertains that the processor 520 may be implemented in other types of hardware.

The artificial neural network model may include an artificial intelligence (AI) model such as a large language model (LLM).

The multi-modal personality data may refer to data that understands and expresses a personality of an individual through multiple different types of information sources. The multi-modal personality data may include information collected from a language, a voice, an image, a video, text, a social media post, and a variety of other media. Understanding and predicting a personality using the multi-modal personality data may help with sentiment analysis, behavior prediction, improving user experience, marketing, and developing personalized services.

The multi-modal personality data may include, for example, language data, voice data, image and video data, text data, and interaction data. A personality trait and emotion may be understood through linguistic data expressed in text or voice. The language data may be collected from an email, a social media post, a chat history, and the like. A tone, a speed, an intonation, a vocal energy, and an emotional state may be identified through voice analysis of voice data. Voice data may be obtained from a voice message, a phone call, a recorded conversation, and the like. Visual information may be obtained from a photo and a video of the image and video data. The personality trait may be identified through a facial expression, a posture, an environment, and visual content of the image and video data. The personality trait and interests may be understood through text data obtained from a text message, a social media post, a web article, and the like. The interaction data may be a variety of data generated when an individual interacts with a digital service. Preferences and a behavior of the user may be identified by analyzing a click pattern, a search query, a purchase history, and a way of using an app through analysis of the interaction data.

The multi-modal personality data may include at least one of linguistic, paralinguistic, and non-linguistic information. Linguistic information, paralinguistic information, and non-linguistic information may be different types of information that play an important role in a communication and information processing related field.

The linguistic information may refer to information that is conveyed through language. The linguistic information may be expressed in a linguistic unit, such as a word, a sentence, and a document, and may include a structure, grammar, semantics, and vocabulary of a language. For example, the linguistic information may include words and sentences included in a text document, an email, a web page, a novel, a paper, and the like.

The paralinguistic information may refer to extralinguistic characteristics, such as a voice, a pronunciation, an intensity of pronunciation, an intonation, a tone, a speed, and an emotional quality of a voice. The paralinguistic information may be used together with language to indicate an emotional nuance or emphasis in the language. For example, in a voice message, an intensity of pronunciation, an intonation, or an emotional tone may be considered part of the paralinguistic information.

The non-linguistic information may refer to information that is not related to language. The non-linguistic information may include visual, auditory, tactile, and olfactory information. The non-linguistic information may be conveyed through senses other than language and may mainly include body language, an image, a picture, a graphic, a gesture, a color, and the like. For example, a human gesture, a photo, a video, a picture, a position of a piece in a chess game, a note and rhythm of music, a structure of a maze, and the like may be part of the non-linguistic information.

A linguistic information type may be important in communication, natural language processing, sentiment analysis, machine learning, computer vision, and a variety of information processing tasks and may be used to improve an interaction and understanding between the human and a machine.

The processor according to an embodiment may train an artificial neural network (ANN) model with the multi-modal personality data described above. A plurality of personality models trained on the multi-modal personality data may include personality models specialized for a single personality. For example, it may be assumed that the multi-modal personality data is labeled as the Big 5 (OCEAN) factors. The Big 5 (OCEAN) factors explain personality traits of an individual with five main dimensions, which are openness, conscientiousness, extroversion, agreeableness, and neuroticism. When the processor trains the artificial neural network (ANN) model with personality data labeled with the Big 5 (OCEAN) factors, the processor may obtain five types of personality models specialized for each of the personality traits.

For example, when the user enters “suggest a hobby for me to do today” into a personality model specialized for extroversion, the personality model may suggest an activity such as exercise that may be done outdoors.

However, the personality model is not limited to the described embodiment and may also be obtained based on a personality such as a calm personality, an impulsive personality, a bright personality, a cool personality, and the like that exists in general.

In operation 120, the processor according to an embodiment may interlock the plurality of personality models with a pipeline-based artificial intelligence (AI) service.

The processor according to an embodiment may provide the plurality of personality models to a user interface of the artificial intelligence (AI) service.

The artificial intelligence (AI) service according to an embodiment may be a service that generates an artificial neural network model suitable for a user, based on an input of the user. In addition, the pipeline-based artificial intelligence (AI) service may refer to a service that provides a framework for efficient development, distribution, and management of various artificial intelligence (AI) technologies and services. Such artificial intelligence (AI) services may help a business, an organization, and a developer develop a variety of applications and services using the artificial intelligence (AI) technologies.

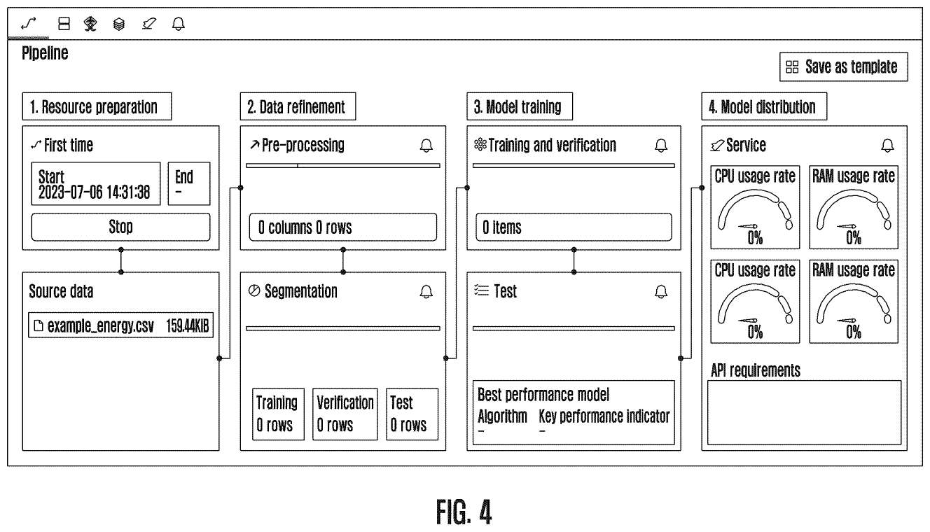

The user interface may be provided to a developer or a user in an easy-to-use block or chat form. For example, the pipeline-based artificial intelligence (AI) service may be provided in the form of a block transformed from an artificial neural network model (e.g., a pipeline of FIG. 4). The plurality of personality models may be provided to the artificial intelligence (AI) service in a block form that the user may easily select to insert to the pipeline, move, and delete from the pipeline.

In operation 130, the processor according to an embodiment may generate a user personality model by combining the plurality of personality models, based on an input of the user for the artificial intelligence (AI) service.

The processor according to an embodiment may determine a priority and a degree of reflection among the plurality of personality models, based on a prompt input of the user and a selection input of the user on the user interface. The processor may adjust the priority and the degree of reflection of the personality models or groups of the personality models in the pipeline.

For example, it may be assumed that the user intends to generate an artificial neural network model having an extrovert and impulsive personality in the artificial intelligence (AI) service. The processor may combine an extrovert personality model with an impulsive personality model to generate a user personality model having an impulsive personality that the user desires.

The processor according to an embodiment may evaluate a user personality model in an intermediate stage, which may be a combination of the plurality of personality models. The processor may iterate an operation of combining a plurality of personality models changing the priority and the degree of reflection among the plurality of personality models until the performance set by the user is achieved.

For example, it may be assumed that, as described above, the user intends to generate an artificial neural network model having an extrovert and impulsive personality, particularly focused on extroversion. In this case, the processor may combine the extrovert personality model with the impulsive personality model in an arbitrary proportion and generate a test output. When the test output is not an output the user desires or determined to be below the set performance, the priority and the degree of reflection of the extrovert personality model and the impulsive personality model may be changed. In this case, a method of testing the performance may include entering, by the user, that the test output is not the desired output. Alternatively, the processor may perform self-supervised learning. Self-supervised learning is a subfield of machine learning and a form of supervised learning. This method refers to training a model without any labels on data or external supervision provided by the human. Instead, the model may extract a feature from data and itself learn.

In operation 140, the processor according to an embodiment may update the artificial intelligence (AI) service based on the user personality model.

A user personality model according to an embodiment may be a model that pre-processes a user input to a language model of the artificial intelligence (AI) service or post-processes an output from a language model of the artificial intelligence (AI) service.

The processor according to an embodiment may provide a user interface that distributes an artificial neural network model generated according to a user input from an updated artificial intelligence (AI) service.

For example, an artificial intelligence (AI) service with an updated user personality model having an extrovert and open personality may distribute an artificial neural network model that produces the following output. When the user enters “recommend a place to have dinner together tonight,” the output may be a place like “a meat restaurant with a barbecue party style grilling meat outdoors.”

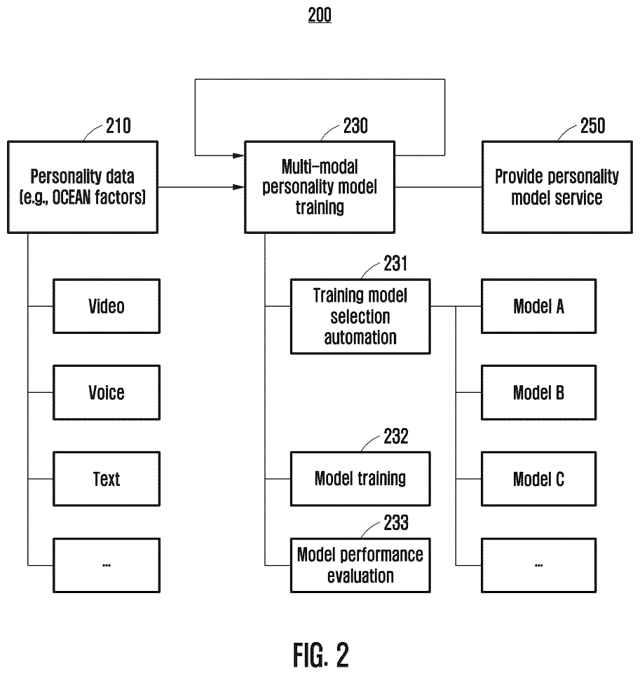

FIG. 2 is a block diagram schematically illustrating a personality model service, according to an embodiment.

The description provided with reference to FIG. 1 may apply to FIG. 2, and any repeated description related thereto may be omitted. One or more blocks shown in FIG. 2 or a combination thereof may be implemented by a special-purpose hardware-based computer that performs a predetermined function or a combination of computer instructions and special-purpose hardware.

An artificial intelligence (AI) service platform 200 according to an embodiment may perform personality model training 230 based on personality data 210 to provide a personality model service 250. The personality data 210 may refer to data related to a personality trait, including a video, a voice, text, and the like. The artificial intelligence (AI) service platform 200 may select a model to be trained via training model selection automation 231 in personality model training and may proceed with model training 232 and model performance evaluation 233 based on the selected model to generate a user personality model. The artificial intelligence (AI) service platform 200 may provide the personality model service 250 by updating an artificial intelligence (AI) service based on the user personality model generated through the multi-modal personality model training 230.

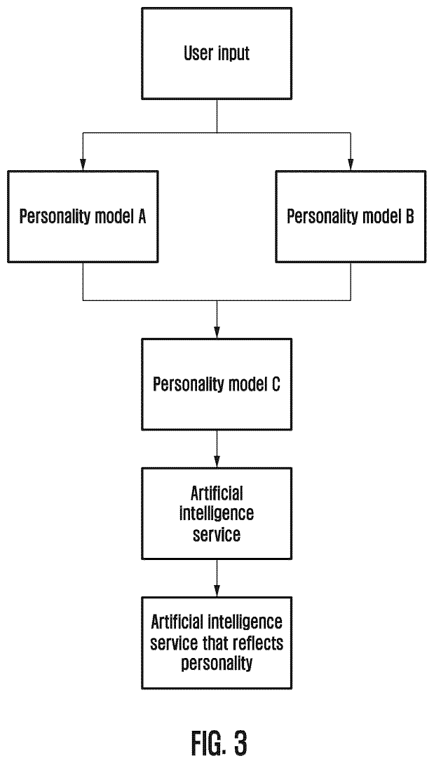

FIG. 3 is a diagram schematically illustrating a personality model being used in a pipeline form, according to an embodiment.

The description provided with reference to FIGS. 1 and 2 may apply to FIG. 3, and any repeated description related thereto may be omitted. One or more blocks shown in FIG. 3 or a combination thereof may be implemented by a special-purpose hardware-based computer that performs a predetermined function or a combination of computer instructions and special-purpose hardware.

The processor according to an embodiment may select a personality model A and a personality model B as target personality models to be combined, based on a user input. The processor may combine the personality model A and the personality model B according to the priority and the degree of reflection to generate an integrated user personality model C. The processor may update the personality model C in the artificial intelligence (AI) service 200. The processor may distribute, via a user interface, an artificial neural network model reflecting a personality in the artificial intelligence (AI) service 200 that reflects the personality model C. A user may obtain an artificial neural network model that reflects a personality via the user interface.

FIG. 4 is a diagram illustrating an example of a pipeline, according to an embodiment.

The description provided with reference to FIGS. 1 to 3 may apply to FIG. 4, and any repeated description related thereto may be omitted.

Referring to FIG. 4, the artificial intelligence (AI) service platform 200 according to an embodiment may build a built artificial neural network into a pipeline-based UI and provide artificial intelligence (AI) service to a user.

The pipeline UI according to an embodiment may include a resource preparation UI, a data refinement UI, a model training UI, and a model distribution UI. However, FIG. 3 is only an example to illustrate a pipeline-based UI and is not intended to be limiting.

The artificial intelligence (AI) service platform 200 may perform model combination and integration. A pipeline-based platform may integrate a variety of artificial intelligence (AI) models. The models may perform a variety of functions and may include, for example, language processing, image analysis, voice recognition, a prediction and recommendation system, and the like.

The artificial intelligence (AI) service platform 200 may perform personality combination. For example, the artificial intelligence (AI) service platform 200 may help generate a customized service by integrating multiple personality models. A user may connect various personality models in a pipeline and effectively combine the personality models.

The artificial intelligence (AI) service platform 200 may set a priority and a degree of reflection with respect to a combination of personality models. The user may set the priority and the degree of reflection of each model or group of models in the pipeline. For example, the artificial intelligence (AI) service platform 200 may control a way of a personality model being executed before other personality models or activated under a certain condition.

The artificial intelligence (AI) service platform 200 may perform data management. For example, the artificial intelligence (AI) service platform 200 may provide a tool and an interface for data management. The user may connect a variety of data to artificial intelligence (AI) service platform 200 and feed the data into an artificial neural network model to utilize the data for a artificial intelligence (AI) service platform 200.

The artificial intelligence (AI) service platform 200 may support batch processing in real time. The artificial intelligence (AI) service platform 200 may indicate that the service is capable of generating a response to a real-time data stream or batch-processed data.

The artificial intelligence (AI) service platform 200 may integrate user-developed models or add a new feature.

FIG. 5 is a block diagram illustrating an electronic device according to an embodiment.

One or more blocks shown in FIG. 5 or a combination thereof may be implemented by a special-purpose hardware-based computer that performs a predetermined function or a combination of computer instructions and special-purpose hardware. The description provided with reference to FIGS. 1 to 4 may also apply to FIG. 5. For example, the electronic device 500 according to an embodiment may include the artificial intelligence (AI) service platform 200.

Referring to FIG. 5, the electronic device 500 may include a memory 510 and a processor 520. The electronic device 500 may further include a communication module, and the communication module may include a transmitter and a receiver.

The electronic device 500 according to an embodiment may include the memory 510 and the processor 520 connected to the memory 510 through a system bus or another suitable circuit.

The electronic device 500 may store program code in the memory 510. The memory 510 according to an embodiment may include a local memory or at least one physical memory device, such as at least one bulk storage device. Here, the local memory may include random-access memory (RAM) or other volatile memory devices generally used during actual execution of the program code. The bulk storage device may be implemented as a hard disk drive (HDD), a solid-state drive (SSD), or other non-volatile memory devices.

In response to executable program code stored in the memory 510 being executed by the electronic device 500, the processor 520 may perform various operations described in the present disclosure. For example, the memory 510 may store program code that causes the processor 520 to perform at least one operation described with reference to FIGS. 1 to 4.

Depending on a type of apparatus being implemented, the electronic device 500 may include fewer components than the illustrated components or may include additional components that are not illustrated in FIG. 5. In addition, at least one component may be included in another component or may constitute a portion of another component.

The processor 520 according to an embodiment may be a hardware component that performs overall control functions for controlling operations of the electronic device 500. For example, the processor 520 may generally control the electronic device 500 by executing programs stored in the memory 510 in the electronic device 500. The processor 520 may be implemented as a central processing unit (CPU), a graphics processing unit (GPU), an application processor (AP), a neural processing unit (NPU), and the like that are provided in the electronic device 500. However, embodiments are not limited thereto.

The processor 520 may obtain a plurality of personality models by training an artificial neural network model with multi-modal personality data, interlock the plurality of personality models with a pipeline-based artificial intelligence (AI) service, generate a user personality model by combining the plurality of personality models, based on an input of a user for the artificial intelligence (AI) service, and update the artificial intelligence (AI) service based on the user personality model.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

1. An operating method of an artificial intelligence (AI) platform, the operating method comprising:
obtaining a plurality of personality models by training an artificial neural network model with multi-modal personality data;
interlocking the plurality of personality models with a pipeline-based artificial intelligence (AI) service;
generating a user personality model by combining the plurality of personality models, based on an input of a user for the artificial intelligence (AI) service; and
updating the artificial intelligence (AI) service based on the user personality model.

2. The operating method of claim 1, wherein the multi-modal personality data comprises:
at least one of linguistic, paralinguistic, and non-linguistic information.

3. The operating method of claim 1, wherein each of the plurality of personality models comprises:
personality models trained with personality data labeled with Big 5 (OCEAN) factors and specialized for a single personality.

4. The operating method of claim 1, wherein the interlocking comprises:
providing the plurality of personality models to a user interface of the artificial intelligence (AI) service.

5. The operating method of claim 4, wherein the generating of the user personality model comprises:
determining, based on a prompt input of the user and a selection input of the user on the user interface, a prioritization and a degree of reflection among the plurality of personality models.

6. The operation method of claim 5, wherein the generating of the user personality model comprises:
evaluating a user personality model in an intermediate stage that is a combination of the plurality of personality models; and
iterating an operation of combining the plurality of personality models changing a priority and a degree of reflection among the plurality of personality models until performance set by the user is achieved.

7. The operating method of claim 1, wherein the artificial intelligence (AI) service is configured to generate an artificial neural network model suitable for the user, based on the input of the user.

8. The operating method of claim 1, wherein the user personality model is configured to pre-process a user input for a language model of the artificial intelligence (AI) service or post-process an output of the language model of the artificial intelligence (AI) service.

9. The operating method of claim 1, further comprising:
providing a user interface for distributing an artificial neural network model generated based on the input of the user in the updated artificial intelligence (AI) service.

10. A non-transitory computer-readable storage medium storing instructions that, when executed by a processor, cause the processor to perform the method of claim 1.

11. An electronic device comprising:
a memory comprising instructions; and
a processor configured to:
obtain a plurality of personality models by training an artificial neural network model with multi-modal personality data;
interlock the plurality of personality models with a pipeline-based artificial intelligence (AI) service;
generate a user personality model by combining the plurality of personality models, based on an input of a user for the artificial intelligence (AI) service; and
update the artificial intelligence (AI) service based on the user personality model.
